(19) United States
(12) Patent Application Publication
(10) Pub. No.: US 2005/0152009 A1
(43) Pub. Date: Jul. 14, 2005

(54) Image scanning device

(76) Inventor: Dong-gyoo Lee, Suwons-si (KR)

Correspondence Address: STANZIONE & KIM, LLP, 1740 N STREET, N.W., FIRST FLOOR, WASHINGTON, DC, 20036, US

(21) Appl. No.: 11/028,320

(22) Filed: Jan. 4, 2005

(30) Foreign Application Priority Data
Jan. 14, 2004 (KR) 2004-2747

(51) Int. Cl. H04N 1/04

(52) U.S. Cl. 358/474

(57) ABSTRACT

An image scanning device provided in an electronic apparatus, such as a scanner, a facsimile, a copying machine and an all-in-one machine, to scan a document. The image scanning device includes a scan sensor unit having a contact surface to contact the document and a scan sensor to scan the document, and a cleaning unit to provide an air flow to the contact surface of the scan sensor unit to remove particulate matter from the contact surface.

### CROSS-REFERENCE TO RELATED APPLICATIONS

This application claims the benefit under 35 U.S.C. § 119 of Korean Patent Application No. 2004-02747, filed Jan. 14, 2004, in the Korean Intellectual Property Office, the disclosure of which is incorporated herein in its entirety and by reference.

### BACKGROUND OF THE INVENTION

1. Field of the Invention

The present general inventive concept relates to an image scanning device to scan an image on a document.

2. Description of the Related Art

Typically, an image scanning device is provided in an electronic apparatus, such as a scanner, a facsimile, a copying machine, and an all-in-one machine, to scan a document. Such image scanning devices are classified into a flat bed type in which a scan sensor unit moves over a stationary document to scan an image on the document, and a sheet feed type in which a document is moved through a stationary scan sensor unit so that an image on the document is scanned by the stationary scan sensor. A flat bed type image scanning device is employed in an apparatus that requires scanning of a high quality, while a sheet feed type image scanning device is employed in an apparatus that requires scanning of a high speed.

FIG. 1 illustrates an all-in-one machine that employs a conventional sheet feed type image scanning device. Referring to FIG. 1, the conventional sheet feed type image scanning device is provided in a body 110 of an all-in-one machine 100, and comprises a scan sensor unit 150 for scanning a document, a paper feeding roller 141 for transporting the document, and a white roller 145. Reference numeral 130 indicates a document tray loaded with plural documents, wherein the document tray is a kind of paper feeding device. Reference numeral 120 indicates a control panel provided to operate the electronic apparatus.

As shown in FIG. 2, the scan sensor unit 150 includes a casing 151 with a contact surface 153 being opposite to the document P transported by the paper-feeding roller 141, and a scan sensor 155 housed in the casing 151 to scan the document P. In general, a CCD (Charge-Coupled Device) or a CIS (Contact Image Sensor) is used as the scan sensor 155, and a transparent glass is employed as the contact surface 153. The paper feeding roller 141 transports the document P in a direction A of FIG. 2.

With the conventional image scanning device configured as described above, the contact surface 153 may be occasionally contaminated by particulate matter D, such as paper dust, soil, etc., from the document P or the environment. In that event, one or more spots or lines may be produced on an image output from the image scanning device, thereby deteriorating a quality of scanning. Accordingly, there is a problem in that it is required to repeatedly clean the contact surface.

In particular, in a sheet feed type scanning device as shown in FIG. 2, the spots or lines are constantly produced on output images as a result of the particulate matter as mentioned above, and thus deterioration of output quality occurs more frequently than in a flat bed type image scanning device. Therefore the particulate matter must be essentially removed. However, because such a sheet feed type image scanning device is generally housed within an electronic device, such as the all-in-one machine 100 of FIG. 1, it is not easy to access the image scanning device, and accordingly, it is not easy for a user to manually remove the particulate matter.

### SUMMARY OF THE INVENTION

Accordingly, the present general inventive concept provides an image scanning device configured to make it easy to remove particulate matter distributed on a contact surface of a scan sensor unit, to thereby prevent a quality of scanning from being deteriorated.

Additional aspects and advantages of the present general inventive concept will be set forth in part in the description which follows and, in part, will be obvious from the description, or may be learned by practice of the general inventive concept.

The foregoing and/or other aspects and advantages of the present general inventive concept are achieved by providing an image scanning device comprising a scan sensor unit having a contact surface to contact a document and a scan sensor to scan the document, and a cleaning unit to provide an air flow to the contact surface of the scan sensor unit, to thereby remove the particulate matter on the contact surface.

The image scanning device makes it easy to remove the particulate matter contaminating the contact surface of the scan sensor unit so that the quality of a scanned image can be prevented from being deteriorated by the particulate matter.

The cleaning unit may comprise an air guide member having a nozzle opened at one end of the air guide member adjacent to the contact surface and an air flow passage connected with the nozzle and formed within the air guide member, and an air flow generator connected to another end of the air guide member to have an air flow path communication between the nozzle and the air flow generator through the air flow passage, wherein the air flow generator forcibly displaces air surrounding the nozzle when it is driven.

The air flow generator may be a vacuum source adapted to render air residing on the contact surface to be inhaled through the nozzle.

The air flow passage may be formed in a shape that becomes more narrow in cross-section as it approaches the nozzle.

The air flow passage may have one or more orifices sequentially formed along the air flowing direction.

The air guide member may comprise a first housing at one end of which the nozzle is opened and at another end of which a first port is opened that is formed in a cross-section smaller than that of the nozzle, and a second housing at one end of which a second port is opened that is connected with the first port to have an air flow communication path between the first port and the second port, and at the other end of which a third port is opened that has a cross-section larger than that of the second port.

The first housing may be arranged in a body of an electronic apparatus so that the end at which the nozzle is opened is located upstream of the contact surface along a document transporting direction, and the nozzle is opened toward a downstream direction of the contact surface with respect to the document transporting direction.

The nozzle may have a width exceeding the maximum width of the document scanned by the scan sensor unit in a direction perpendicular to the document transporting direction.

The image scanning device may further comprise a paper transporting unit having at least one roller to transport the document, and the scan sensor unit is fixedly installed on a transporting route of the document transported by the roller.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view illustrating an all-in-one machine employing a conventional image scanning device;

FIG. 2 is a schematic view illustrating the conventional image scanning device of FIG. 1 along a document transporting direction;

FIG. 3 is a schematic view illustrating an image scanning device according to an embodiment of the present general inventive concept;

FIG. 4 is an exploded perspective view illustrating an air guide member of FIG. 3; and

FIG. 5 is a perspective view illustrating a lower surface of a second housing of FIG. 4.

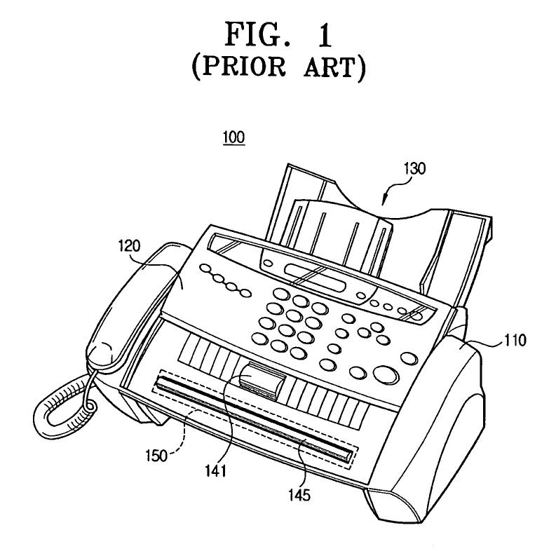

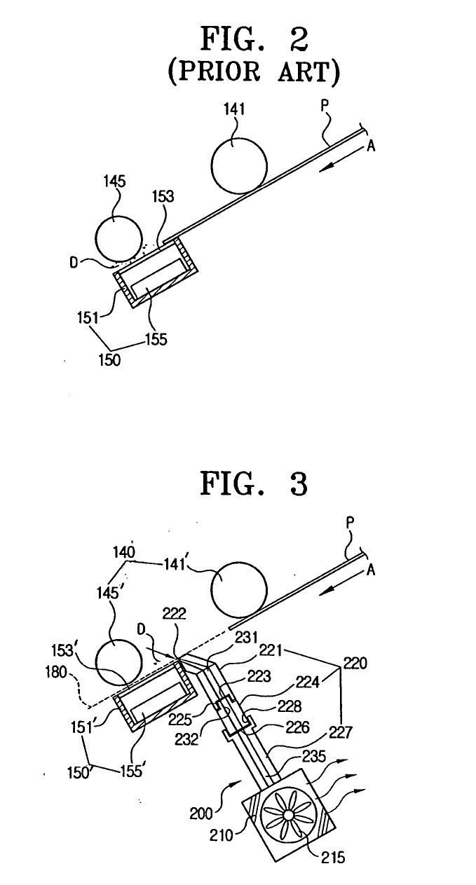

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept while referring to the figures.

FIG. 3 illustrates a sheet feed type image scanning device usable with an electronic apparatus. Referring to FIG. 3, the image scanning device according to an embodiment of the present general inventive concept comprises a document transporting unit 140, a scan sensor unit 150′ and a cleaning unit 200.

The document transporting unit 140 transports a document P loaded in a document tray of the electronic apparatus to the scan sensor unit 150′ sheet by sheet, and discharges the document out of the image scanning device after the scan sensor unit 150′ scans the document P. The document transporting unit 140 can comprise a paper-feeding roller 141′, a white roller 145′, and a paper-discharge roller (not shown). In a flat bed type image scanning device in which the scan sensor unit 150′ moves to scan the document P, the document transporting unit 140 may be omitted.

The scan sensor unit 150′ scans the document P and comprises a casing 151′ with a contact surface 153′ being disposed against the document P when the document P is positioned at a scanning position, and a scan sensor 155′ provided within the casing 151′. In the case of using a sheet feed type image scanning device as shown in FIG. 3, the scan sensor 155′ can comprise a CIS (contact image sensor) to facilitate fabrication and control of the image scanning device.

The cleaning unit 200 is provided to provide an air flow to the contact surface 153′ of the scan sensor unit 150′ to thereby remove particulate matter D, such as dust particles, soil, etc., from the contact surface 153′. The cleaning unit 200 according to this embodiment of the present general inventive concept is configured to inhale the air adjacent to and in contact with the contact surface 153′ to remove the particulate matter D, and comprises an air guide member 220 and an air flow generator 210.

The air guide member 220 has one end located adjacent to the contact surface 153′ and another end connected to the air flow generator 210 to have an air flow communication with the air flow generator 210. A nozzle 222 is formed through the one end of the air guide member 220 adjacent to the contact surface 153′. In addition, air flow passages 231, 232 and 235 are formed through the interior of the air guide member 220 to connect the air flow generator 210 and the nozzle 222, so that the air flow generator 210 and the nozzle 222 have an air flow communication path between each other.

The air flow generator 210 acts as a vacuum source to forcibly generate air flow so that the air residing adjacent to and in contact with the contact surface 153′ is forcibly inhaled through the nozzle 222. The air flow generator 210 can comprise an inhaling fan 215 and a motor (not shown) to rotationally drive the inhaling fan 215. The air flow generator 210 may be provided separately from the electronic apparatus. However, the air flow generator 210 may already be installed within the electronic apparatus to circulate or cool air upon manufacturing thereof, and as such, is not required to be separately provided with respect to the electronic apparatus. If the air flow generator 210 already installed in the electronic apparatus is used, the air guide member 220 may be formed to correspond with the air flow generator 210 already installed in the electronic apparatus. In addition, the cleaning unit 200 may be formed in a construction adapted to blow air towards the contact surface 153′ to thereby remove the particulate matter D, and the air flow generator 210 can therefore act as a blower to blow the air through the nozzle 222 towards the contact surface 153′.

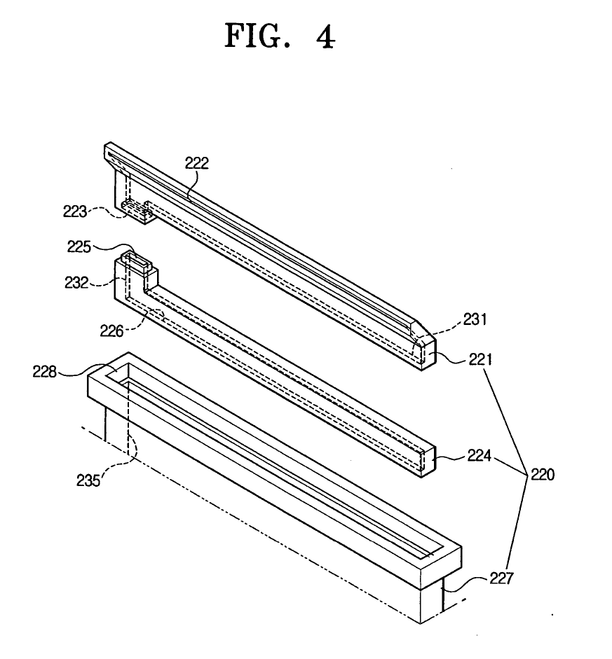

As described above, if the cleaning unit 200 removes the particulate matter D on the contact surface 153′ by inhaling air, the air flow passages 231, 232 and 235 formed within the air guide member 220 can comprise one or more orifices sequentially formed along an air flowing direction to enhance an efficiency of the inhaling of the air. However, if the air guide member 220 is formed as a single body, there arises a problem that it is not easy to form the one or more orifices through the air flow passages 231, 232 and 235 formed within the air guide member 220. Thus, the air guide member 220 can alternatively comprise a first housing 221, a second housing 224 and a connection tube 227, as illustrated in FIG. 4.

Referring to FIG. 4, the first housing 221 is installed adjacent to the contact surface 153′ of the scan sensor unit 150′ and comprises the nozzle 222, a first port 223, and a first air flow passage 231. The nozzle 222 is an inlet to inhale the air residing adjacent to and in contact with the contact surface 153′ along with the particulate matter D as described above. The first port 223 is formed at a lower end of the first housing 221 to connect the first housing 221 to the second housing 224. The first air flow passage 231 is formed through an interior of the first housing 221 so as to connect the first port 223 and the nozzle 222 to have an air flow communication path between each other.

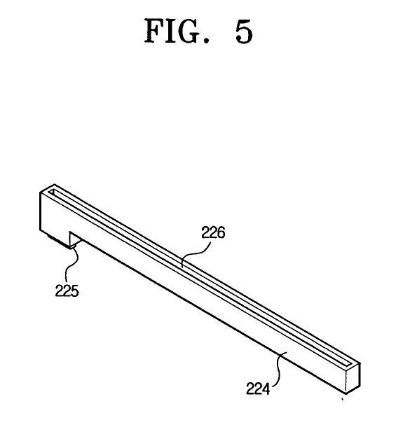

The second housing 224 is connected to the lower end of the first housing 221 and comprises a second port 225, a third port 226, and a second air flow passage 232 as illustrated in FIGS. 4 and 5. Referring to FIGS. 4 and 5, the second port 225 is formed at a top end of the second housing 224, and is interference-fitted with the first port 223 of the first housing 221 when assembling the first and second housings 221 and 224 to thereby connect the first and second housings 221 and 224 so that the first and second housings 221 and 224 have an air flow communication path between each other. The third port 226 is formed at a lower end of the second housing 224 and connects with the connection tube 227. The second air flow passage 232 is formed through an interior of the second housing 224 to connect the second and third ports 225 and 226 so that the second and third ports 225 and 226 have an air flow communication path between each other.

The connection tube 227 is provided to connect the second housing 224 and the air flow generator 210 so that the second housing 224 and the air flow generator 210 have an air flow communication path between each other, in which one end 228 of the connection tube 227 is connected with the third port 226 of the second housing 224 and another end thereof is connected with the air flow generator 210. Although the connection tube 227 is exemplified as being formed as a duct shape in FIGS. 3 and 4, the connection tube 227 may be formed in various shapes, such as a tubular shape and a hose shape, as long as a third air flow passage 235 is formed within the connection tube 227. In addition, if the second housing 224 is directly connected with the air flow generator 210, it is possible to omit the connection tube 227. Further, it is possible that the third air flow passage 235 formed within the connection tube 227 is formed in a shape that becomes more narrow in cross-section as it approaches the air flow generator 210 to thereby enhance the inhaling efficiency of the cleaning unit 200.

The air guide member 220 can be formed with one or more orifices within the interior thereof. For example, it is possible that the first port 223 is formed to have a cross-section smaller than that of the nozzle 222, and the second port 225 is formed to have a cross-section smaller than that of the third port 226. With this arrangement, if the first air flow passage 231 and the second air flow passage 232 are connected to one another, the cross-sectional area at the connection part between them is narrower than the other parts, which forms an orifice capable of enhancing the air inhaling efficiency.

Meanwhile, in order to improve a cleaning efficiency of the contact surface 153′, the particulate matter D can be removed before it arrives at the contact surface 153′. Thus, the first housing 221 can be arranged so that a top end thereof formed with the nozzle 222 is located upstream of the scan sensor unit 150′ with respect to a document transporting direction A (see FIG. 3).

In addition, to efficiently remove the particulate matter D from the contact surface 153′, the nozzle 222 is opened at the top end of the first housing 221 to be directed toward a downstream direction of the contact surface 153′ with respect to the document transporting direction A (see FIG. 3). At this time, although the top end of the first housing 221 is partially projected above a document transporting route 180 (see FIG. 3), such a projection will not deteriorate the capability of the entire image scanning device if the projection is formed to a height so as not to disturb the transportation of the document P.

Furthermore, it is possible that the nozzle 222 has a width which is not less than that of the contact surface 153′ to remove the particulate matter D from a surrounding area of the contact surface 153′ as well as from the entire contact surface 153′.

It is also possible that a part of the first air flow passage 231 corresponding to the top end of the first housing 221 is formed to become more narrow as it approaches the nozzle 222 to increase a flow speed of the air through the nozzle, thus improving the cleaning efficiency of the cleaning unit 200. Moreover, if the size of the nozzle 222 is reduced, it is possible to greatly reduce the size of the top end of the first housing 221 projected on the document transporting route 180.

It is to be noted that the cleaning unit 200 as described above should not be limited to the configuration shown in the drawings. That is, if the cleaning unit 200 has a construction capable of removing particulate matter from the contact surface 153′ by inhaling or blowing, it is possible to form the air guide member 220 and the air flow generator 210 in various forms and constructions to correspond to a construction of the electronic apparatus and a installation position of the image scanning device.

According to the present general inventive concept, because particulate matter can be removed by displacing air residing on a contact surface of a scan sensor unit, it is possible to alleviate problems that a user may experience when cleaning the contact surface of the scan sensor unit, thereby preventing the quality of scanning from being deteriorated by the contamination of the contact surface.

Furthermore, although it is troublesome for a user to manually remove particulate matter because it is not easy to access a sheet feed type image scanning device installed within an electronic machine, the particulate matter on the contact surface can be easily removed if the cleaning unit according to the present general inventive concept is used.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. An image scanning device provided in an electronic device to scan a document, comprising:
a scan sensor unit having a contact surface to contact the document and a scan sensor to scan the document; and
a cleaning unit to urge air residing adjacent to and in contact with the contact surface of the scanning sensor unit to provide an air flow to remove particulate matter from the contact surface.

2. An image scanning device as claimed in claim 1, wherein the cleaning unit comprises:
a nozzle opened at one end of the cleaning unit adjacent to the contact surface;
an air flow generator to forcibly displace air surrounding the nozzle; and
an air flow passage to connect the nozzle and the air flow generator such that the nozzle and the air flow generator have an air flow path communication with each other.

3. An image scanning device as claimed in claim 2, wherein the air flow generator is a vacuum source adapted to render air residing on the contact surface to be inhaled through the nozzle.

4. An image scanning device as claimed in claim 2, wherein the air flow passage is formed in a shape that becomes more narrow in cross-section as it approaches the nozzle.

5. An image scanning device as claimed in claim 2, wherein the air flow passage has one or more orifices sequentially formed along an air flowing direction.

6. An image scanning device as claimed in claim 2, wherein the airflow passage comprises:
a first housing, at one end of which the nozzle is opened and at another end of which a first port is opened that has a cross-section smaller than that of the nozzle; and
a second housing, at one end of which a second port is opened that connects with the first port to provide an air flow communication between the first port and the second port, and at another end of which a third port is opened that has a cross-section larger than that of the second port,
wherein the air flow passage extends through an interior of the first and second housings when the first and second housings are connected with each other.

7. An image scanning device as claimed in claim 6, wherein the first housing is arranged so that the end thereof at which the nozzle is opened is located upstream of the contact surface along a document transporting direction, and
the nozzle is opened toward a downstream direction of the contact surface with respect to the document transporting direction.

8. An image scanning device as claimed in claim 6, wherein a width of the nozzle in a direction perpendicular to a document transporting direction is not less than a width of the contact surface in a direction perpendicular to the document transporting direction.

9. An image scanning device as claimed in claim 2, further comprising a paper transporting unit comprising at least one roller to transport the document, and wherein the scan sensor unit is fixedly installed on a transporting route of the document transported by the roller.

10. An image scanning apparatus comprising:
a contact surface to contact a document;
a scanning unit to scan an image from the document;
an air flow generator to generate an air flow; and
an air guide member to communicate the air flow with the contact surface to remove particulate matter from the contact surface.

11. The image scanning apparatus as claimed in claim 10, wherein the air guide member comprises a nozzle provided on an end thereof adjacent to the contact surface to direct the air flow toward or away from the contact surface.

12. The image scanning apparatus as claimed in claim 11, wherein the air flow is a suction air flow to inhale the particulate matter into the air guide member.

13. The image scanning apparatus as claimed in claim 11, wherein the air flow is a blowing air flow to displace the particulate matter from the contact surface.

14. The image scanning apparatus as claimed in claim 10, wherein the air guide member becomes more narrow as it approaches the contact surface.

15. The image scanning apparatus as claimed in claim 10, wherein the air guide member becomes more narrow as it approaches the air flow generator.

16. The image scanning apparatus as claimed in claim 10, wherein the air guide member comprises one or more reduced portions having a cross sectional area smaller than the remaining portions thereof.

17. The image scanning apparatus as claimed in claim 10, wherein the guide member comprises:
a first housing disposed adjacent to the contact surface;
a second housing connected with the first housing at a connecting portion having a smaller cross sectional area than a cross sectional area of the first or second housings; and
a connection tube to connect the second housing to the air flow generator.

18. A cleaning unit connectable within a scanning device to remove particulate matter from a contact surface of the scanning device, the cleaning unit comprising:
an air flow generator to generate an air flow; and
an air guide member to communicate the air flow with the contact surface.

19. The cleaning unit as claimed in claim 18, wherein the air guide member comprises a nozzle at one end thereof to direct the air flow toward the contact surface.

20. The cleaning unit as claimed in claim 19, wherein the air guide member further comprises:
a plurality of air flow passages connecting the air flow generator with the nozzle, the plurality of air flow passages being connected in series between the air flow generator and the nozzle by a plurality of connecting portions each having a cross sectional area smaller than the remaining portions of the plurality of air flow passages.

21. The cleaning unit as claimed in claim 19, wherein the air flow is a suction air flow to inhale the particulate matter into the nozzle.

22. The cleaning unit as claimed in claim 19, wherein the air flow is a blowing air flow to blow air out of the nozzle and onto the contact surface of the scanning device.
